(19) United States
(12) Patent Application Publication
(10) Pub. No.: US 2018/0120686 A1
(43) Pub. Date: May 3, 2018

(54) ROAD SURFACE DISPLAYING DEVICE

(71) Applicant: DENSO CORPORATION, Kariya-city, Aichi-pref. (JP)

(72) Inventors: Kunihiko Hayashi, Kariya-city, Aichi-pref. (JP); Narihiro Haneda, Kariya-city, Aichi-pref. (JP)

(21) Appl. No.: 15/567,854

(22) PCT Filed: Mar. 28, 2016
(86) PCT No.: PCT/JP2016/001786

§ 371 Date: Oct. 19, 2017

(30) Foreign Application Priority Data
Apr. 24, 2015 (JP) 2015-89407

(51) Int. Cl. G03B 21/20; B60Q 1/50; H04N 9/31

(52) U.S. Cl. CPC G03B 21/2073; G03B 21/2033; B60Q 2400/50; H04N 9/3185; B60Q 1/50

(57) ABSTRACT

A road surface displaying device capable of performing a display having high visibility is provided. The road surface displaying device includes a light projecting unit that projects light toward a road surface and performs a display by the light on the road surface, and a polarization controlling unit that sets a ratio of P-polarized light and S-polarized light in the light. The road surface displaying device includes a target position detecting unit that detects a position of a target. The polarization controlling unit sets the ratio according to the position of the target.

### CROSS REFERENCE TO RELATED APPLICATION

This application is based on Japanese Patent Application No. 2015-89407 filed on Apr. 24, 2015, the disclosure of which is incorporated herein by reference.

### TECHNICAL FIELD

The present disclosure relates to a road surface displaying device.

### BACKGROUND ART

It has been known to place an optical material reflecting visible light of specific frequency on a road and project the visible light of the specific frequency from a track predicting device mounted to a vehicle, and thereby to perform a display (see patent literature 1).

### PRIOR ART LITERATURE

### Patent Literature

Patent literature 1: JP-2005-139772A

### SUMMARY OF INVENTION

In an art disclosed in the patent literature 1, a quantity of light reaching to a pedestrian or the like, which exists out of the vehicle, from the optical material is not sufficient and it is difficult for the pedestrian or the like to visually recognize the display.

In view of the foregoing issues, it is an object of the present disclosure to provide a road surface displaying device capable of performing a display having high visibility.

According to an aspect of the present disclosure, a road surface displaying device includes a light projecting unit and a polarization controlling unit. The light projecting unit projects light toward a road surface and performs a display by the light on the road surface. The polarization controlling unit sets a ratio of P-polarized light and S-polarized light in the light. The road surface displaying device sets the ratio of the P-polarized light and the S-polarized light in the light. As such, visibility of the display for pedestrian or the like is improved.

### BRIEF DESCRIPTION OF DRAWINGS

The above and other objects, features and advantages of the present disclosure will become more apparent from the following detailed description made with reference to the accompanying drawings, in which:

FIG. 1 is a block diagram illustrating an electrical structure of a road surface displaying device;

FIG. 2 is an explanatory diagram illustrating a structure of a light projecting unit;

FIG. 3 is an explanatory diagram illustrating a structure of a polarization plate;

FIG. 4 is an explanatory diagram illustrating an optical path of a light projected by the light projecting unit;

FIG. 5 is a flowchart diagram illustrating a processing executed by the road surface displaying device;

FIG. 6 is an explanatory diagram illustrating a first region and a second region;

FIG. 7 is a block diagram illustrating an electrical structure of a light projecting unit;

FIG. 8 is a perspective view illustrating a structure of a polarization plate holder;

FIG. 9 is a block diagram illustrating an electrical structure of a light projecting unit;

FIG. 10 is a block diagram illustrating a structure of a light projecting unit;

FIG. 11 is an explanatory diagram illustrating a structure of a ½λ plate;

FIG. 12 is a block diagram illustrating an electrical structure of a light projecting unit;

FIG. 13 is a block diagram illustrating a structure of a light projecting unit; and

FIG. 14 is a perspective view illustrating a structure of a ½λ plate holder.

### DESCRIPTION OF EMBODIMENTS

Embodiments will be described with reference to the drawings.

### First Embodiment

1. Structure of Road Surface Displaying Device 1.

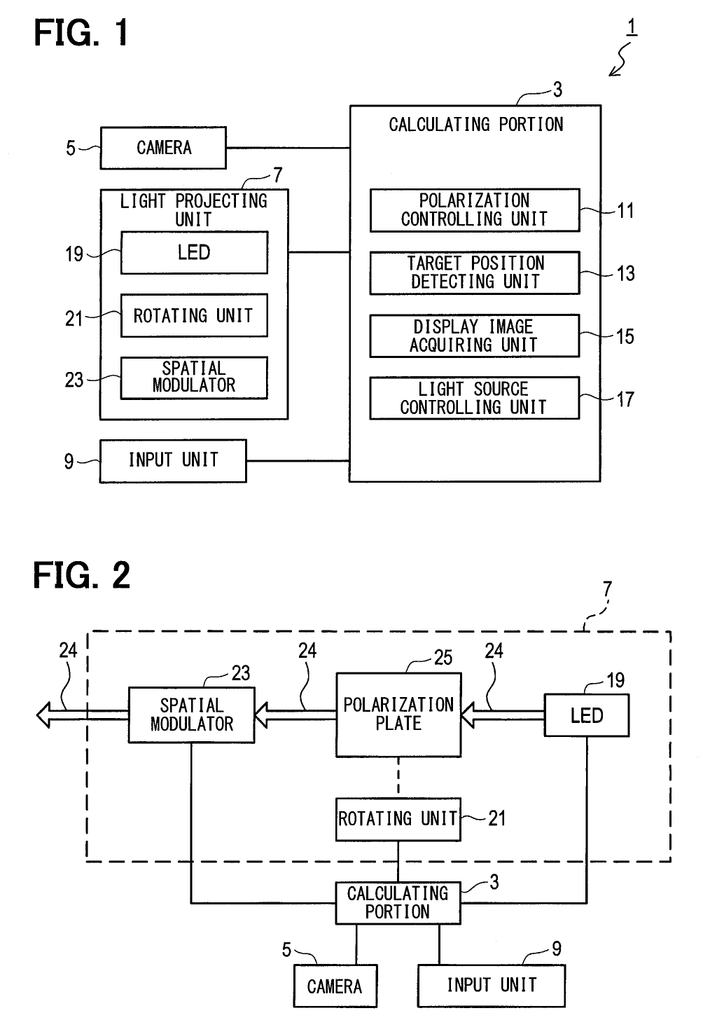

An electrical structure of a road surface displaying device 1 will be described with reference to FIG. 1. The road surface displaying device 1 is a vehicle-mounted device mounted to a vehicle. Hereinafter, a vehicle to which the road surface displaying device 1 is mounted will be referred to as an own vehicle. The road surface displaying device 1 includes a calculating portion 3, a camera 5, a light projecting unit 7 and an input unit 9.

The calculating portion 3 is a well-known computer having a CPU, a RAM, a ROM and the like. The calculating portion 3 executes processing described later by a program stored in the ROM. The calculating portion 3 controls each unit of the road surface displaying device 1. The calculating portion 3 functionally includes a polarization controlling unit 11, a target position detecting unit 13, a display image acquiring unit 15 and a light source controlling unit 17. The function of each unit will be described later.

The camera 5 is attached near a front edge of the own vehicle. The camera 5 takes pictures of scenery in front of the own vehicle and prepares image data. The prepared image data is transmitted to the calculating portion 3.

The light projecting unit 7 projects a light toward a road surface in front of the own vehicle and performs a display by the light on the road surface. The light projecting unit 7 includes a light emitting diode (i.e., LED) 19, a rotating unit 21 and a spatial modulator 23, as an electrical structure. The LED 19 emits visible light.

The rotating unit 21 sets a ratio of P-polarized light and S-polarized light (which is hereinafter referred to as a P/S ratio) in the light emitted by the LED 19 with a polarization plate 25, which will be described later. The details will be described later.

The LED 19 is one example of a circularly polarized light source. Other circularly polarized light source may be employed instead of the LED 19. For example, as the other circularly polarized light source, a halogen lamp, a high-intensity discharge (HID) lamp and the like may be employed.

For example, the polarization plate 25 is a film having minute slits and allows only polarized light parallel to the slits to pass through the film. The polarization plate 25 converts a non-linearly polarized light (e.g., a circularly polarized light such as laser) into linearly polarized light. An angle of a polarization plane (i.e., the P/S ratio) depends on an angle of the polarization plate 25. As the polarization plate 25, a ¼λ plate and the like may be employed. The ¼λ plate is made of a material causing birefringence such as crystal, isinglass and the like. A thickness of the ¼λ plate is adjusted so that ¼λ of phase lag occurs in the birefringence light. When the ¼λ plate is employed, it is preferable to employ the ¼λ plate together with the light source such as LED, HID and the like.

The spatial modulator 23 is a well-known digital mirror device (DMD). The spatial modulator 23 spatially modulates the light emitted by the LED 19 into a light expressing an image such as letters, figures and the like.

The input unit 9 is placed inside of the own vehicle and receives driver's input operation. For example, the driver's input operation includes settings by manual input of start and finish of the road surface display, selection of the image to be displayed on the road and the P/S ratio.

Next, the light projecting unit 7 will be described more precisely with reference to FIG. 2 to FIG. 4. As shown in FIG. 2, the light projecting unit 7 includes the polarization plate 25. The light 24 emitted by the LED 19 passes through the polarization plate 25 and is spatially modulated by the spatial modulator 23, and then projected toward the road surface. That is, the polarization plate 25 and the spatial modulator 23 are located on an optical axis of the light 24.

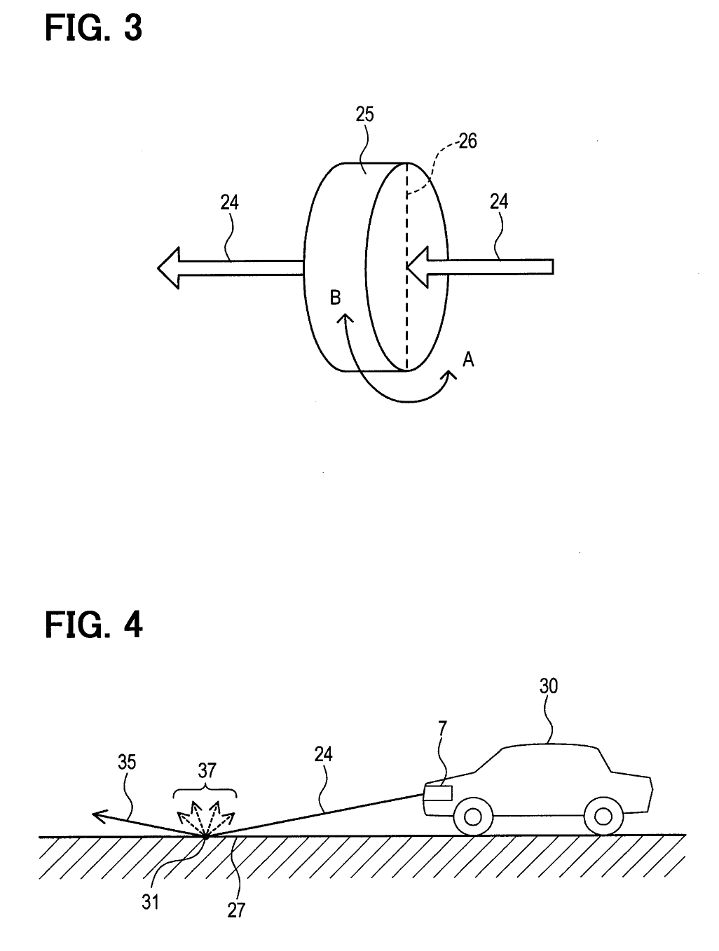

As shown in FIG. 3, the rotating unit 21 rotates the polarization plate 25 in A direction or B direction to change the angle of the polarization plate 25. These rotation directions are a direction in which a gradient of an optical axis 26 of the polarization plate 25 changing with respect to a polarization direction of the light 24 entering the polarization plate 25.

The P/S ratio of the light 24 passing through the polarization plate 25 varies depending on the angle of the polarization plate 25. That is, depending on the angle of the polarization plate 25, the P/S ratio of the light 24 passing through the polarization plate 25 is changed to a ratio substantially including only P-polarized light, and is changed to a ratio substantially including only S-polarized light.

The above described P-polarized light corresponds to a light having a polarization plane orthogonal to a road surface 27 (which is shown in FIG. 4) when the road surface 27 toward which the light 24 is projected from the light projecting unit 7 is defined as an entrance plane. The above described S-polarized light corresponds to a light having a polarization plane orthogonal to the P-polarized light.

The rotating unit 21 is controlled by a polarization controlling unit 11 of the calculating portion 3. By controlling the rotating unit 21, the polarization controlling unit 11 can set the P/S ratio of the light 24 passing through the polarization plane 25 (i.e., the light 24 entering the road surface 27) into the ratio substantially including only P-polarized light and the ratio substantially including only S-polarized light.

2. Processing Executed by Road Surface Displaying Device 1

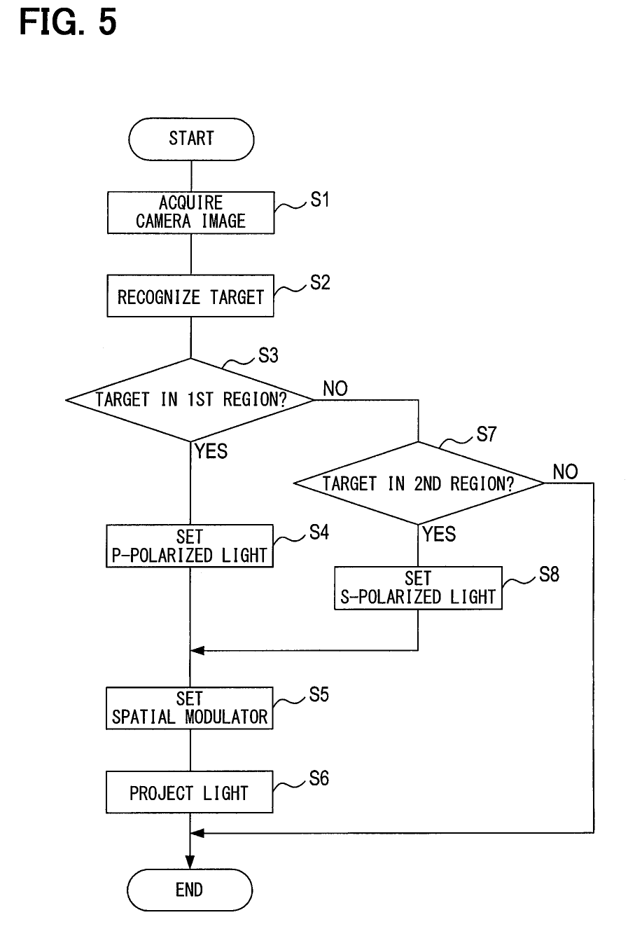

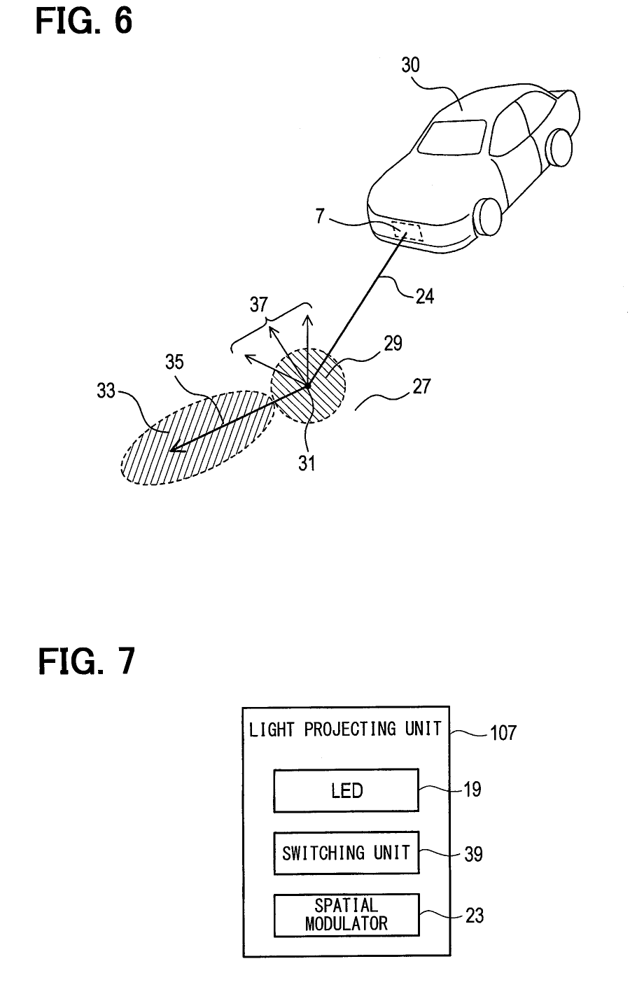

Processing executed by the road surface displaying device 1 (especially by the calculating portion 3) will be described with reference to FIG. 5 and FIG. 6. These processing are executed when the input unit 9 receives an input instructing a start of the road surface display.

At step 1, the target position detecting unit 13 acquires an image of an area in front of the own vehicle shot by the camera 5.

At step 2, the target position detecting unit 13 executes a processing to recognize the target in the image acquired at the step 1, by using well-known image recognition techniques. The target that is to be recognized is, for example, a pedestrian, a bicycle and other vehicle.

At step 3, target position detecting unit 13 detects a position of the target recognized at the step 2. Then, the target position detecting unit 13 determines whether the position of the target is within a first region 29. As shown in FIG. 6, the first region 29 is a region on the road surface 27 in front of the own vehicle 30, and the first region 29 is the region having a distance equal to or shorter than a predetermined value from an incident point 31 at which the light 24 enters the road surface 27. The position of the target is detected based on coordinates of the target in a vertical direction and a horizontal direction in the image. The position of the target may be detected by using millimeter wave radar and the like.

In a case where the position of the target is within the first region 29, the processing proceeds to a step 4. In the other cases (e.g., a case where the position of the target is out of the first region 29 or a case where the target is not recognized), the processing proceeds to a step 7.

At step 4, the polarization controlling unit 11 sets the P/S ratio of the light 24 entering the road surface 27 into the ratio substantially including only P-polarized light.

At step 5, the display image acquiring unit 15 outputs the information of the image to be displayed by the light 24 to the spatial modulator 23.

At step 6, the light source controlling unit 17 turns on the LED 19 to project the light from the light projecting unit 7 toward the road surface. The light to be projected toward the road surface displays the image outputted to the spatial modulator 23 at the step 5. In a case where the processing at the step 4 is executed, the P/S ratio of the light to be projected is the ratio substantially including P-polarized light. In a case where a processing at a step 8 is executed, which will be described later, the P/S ratio of the light to be projected is the ratio substantially including S-polarized light.

On the other hand, in a case where a negative determination is made at the step 3, the processing proceeds to the step 7. At the step 7, the target position detecting unit 13 detects the position of the target recognized at the step 2. Then, the target position detecting unit 13 determines whether the position of the target is within a second region 33.

As shown in FIG. 6, the second region 33 is a region on the road surface 27 and along a reflected light 35 of the light 24 reflected on the road surface 27. In a case where the position of the target is within the second region 33, the processing proceeds to the step 8. In the other cases (e.g., a case where the position of the target is out of the second region 33 or a case where the target is not recognized), the processing is finished.

At the step 8, the polarization controlling unit 11 sets the P/S ratio of the light 24 entering the road surface 27 into the ratio substantially including S-polarized light.

3. Manual Setting of P/S Ratio

The input unit 9 has a function of receiving an input of the P/S ratio by the user. When the P/S ratio is inputted into the input unit 9, the polarization controlling unit 11 sets the P/S ratio of the light 24 to be consistent with the inputted P/S ratio.

4. Effects of the Road Surface Displaying Device 1

(1A) The road surface displaying device 1 sets the P/S ratio of the light 24. When the P/S ratio of the light 24 is set to the ratio substantially including the P-polarized light, as shown in FIG. 6, the light 24 is mainly scattered and reflected to generate scattered light 37. The scattered light 37 is easily viewable for the target in the first region 29 close to the incident point 31. That is, the road surface displaying device 1 performs the display easily viewable for the target in the first region 29 by setting the P/S ratio of the light 24 into the ratio substantially including the P-polarized light.

When the P/S ratio of the light 24 is set to the ratio substantially including the S-polarized light, as shown in FIG. 6, the light 24 is mainly reflected directly to generate the reflected light 35. The reflected light 35 is easily viewable for the target in the second region 33 along the reflected light 35. That is, the road surface displaying device 1 performs the display easily viewable for the target in the second region 33 by setting the P/S ratio of the light 24 into the ratio substantially including the S-polarized light.

(1B) The road surface displaying device 1 detects the position of the target and sets the P/S ratio according to the position of the target. As such, the road surface displaying device 1 performs easily viewable display according to the position of the target.

(1C) The road surface displaying device 1 includes the LED 19 as the light source and sets the P/S ratio by using the polarization plate 25. As such, the road surface displaying device 1 sets the P/S ratio by simple structures.

(1D) The road surface displaying device 1 sets the P/S ratio by rotating the polarization plate 25. As such, the road surface displaying device 1 sets the P/S ratio by simple structures.

(1E) The road surface displaying device 1 projects the light expressing the image (e.g., letters or figures) on the road surface to display the image on the road surface.

### Second Embodiment

1. Differences from First Embodiment

Basic structures of the second embodiment are similar to the first embodiment. Therefore, descriptions of common structures will be omitted and different structures will be mainly described.

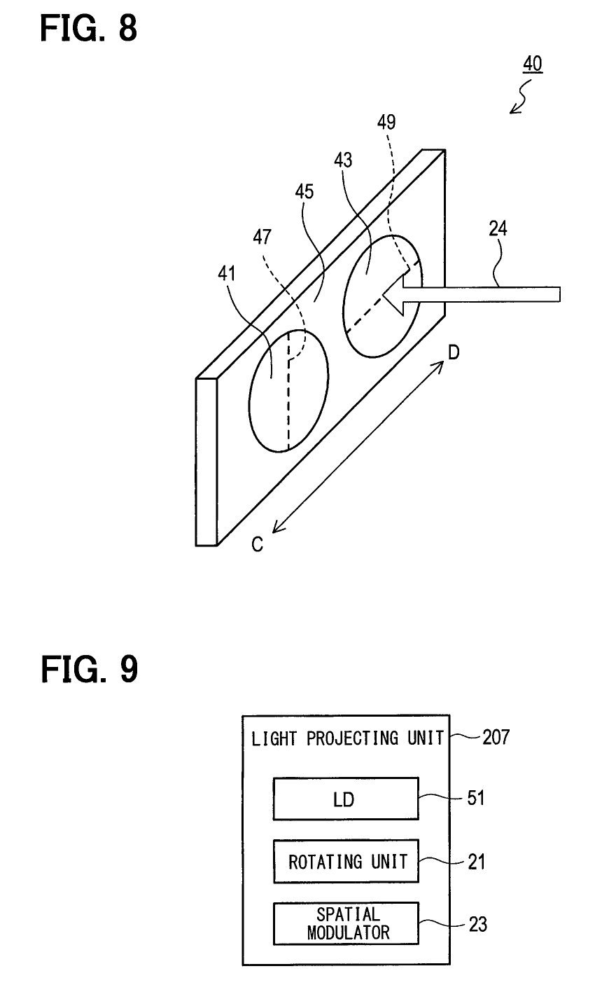

As shown in FIG. 7, the light projecting unit 107 includes a switching unit 39. The light projecting unit 107 includes a polarization plate holder 40 shown in FIG. 8. The polarization plate holder 40 includes two polarization plates 41, 43 and a frame 45 holding the polarization plates 41 and 43. The optical axis 47 of the polarization plate 41 and the optical axis 49 of the polarization plate 43 are shifted from each other by 90 degrees. The P/S ratio of the light 24 passing through the polarization plate 41 is the ratio substantially including the P-polarized light. The P/S ratio of the light 24 passing through the polarization plate 43 is the ratio substantially including the S-polarized light. The polarization plate 41 and 43 are one example of a group of polarization plates whose directions of optical axes are different from each other.

The switching unit 39 slides the polarization plate holder 40 in C direction or D direction shown in FIG. 8. When the switching unit 39 slides the polarization plate holder 40 in the C direction, the polarization plate 43 is located on the optical axis of the light 24 and the polarization plate 41 is located out of the optical axis of the light 24. In this case, the P/S ratio of the light 24 passing through the polarization plate 43 is the ratio substantially including the S-polarized light.

On the other hand, when the switching unit 39 slides the polarization plate holder 40 in the D direction, the polarization plate 41 is located on the optical axis of the light 24 and the polarization plate 43 is located out of the optical axis of the light 24. In this case, the P/S ratio of the light 24 passing through the polarization plate 41 is the ratio substantially including the P-polarized light. That is, the switching unit 39 selects the polarization plate to be located on the optical axis of the light 24 from the polarization plates 41 and 43.

The switching unit 39 is controlled by the polarization controlling unit 11 of the calculating portion 3. By controlling the switching unit 39 to slide the polarization plate holder 40 in the C direction or the D direction, the polarization controlling unit 11 can set the P/S ratio of the light 24 entering the road surface 27 into the ratio substantially including only P-polarized light and the ratio substantially including only S-polarized light.

2. Effects of Road Surface Displaying Device 1

According to the above described second embodiment, the following effects are achieved in addition to the effects (1A) to (1C) and (1E) of the previously described first embodiment.

(2A) The road surface displaying device 1 sets the P/S ratio by selecting the polarization plate to be located on the optical axis of the light 24 from the polarization plates 41 and 43 whose directions of optical axes are different from each other. As such, the P/S ratio is set by simple structures.

### Third Embodiment

1. Differences from First Embodiment

Basic structures of the third embodiment are similar to the first embodiment. Therefore, descriptions of common structures will be omitted and different structures will be mainly described.

As shown in FIG. 9, the light projecting unit 207 includes a laser diode (LD) 51 as the light source. As shown in FIG. 10, the light projecting unit 207 includes a ½λ (lambda) plate 53 on the optical axis of the light 24. The light 24 emitted by the LD 51 passes through the ½λ plate 53 and is spatially modulated by the spatial modulator 23, and then is projected towards the road surface. LD 51 is one example of a linearly polarized light source. A light source other than the LD 51 may be employed as the linearly polarized light source.

The ½λ plate 53 is made of a material causing birefringence such as crystal, isinglass and the like. A thickness of the ½λ plate is adjusted so that the constituent of the birefringence causes a phase lag corresponding to just half of a wavelength of the light emitted by the LD 1. The ½λ plate 53 changes the polarization angle of the linearly polarized light.

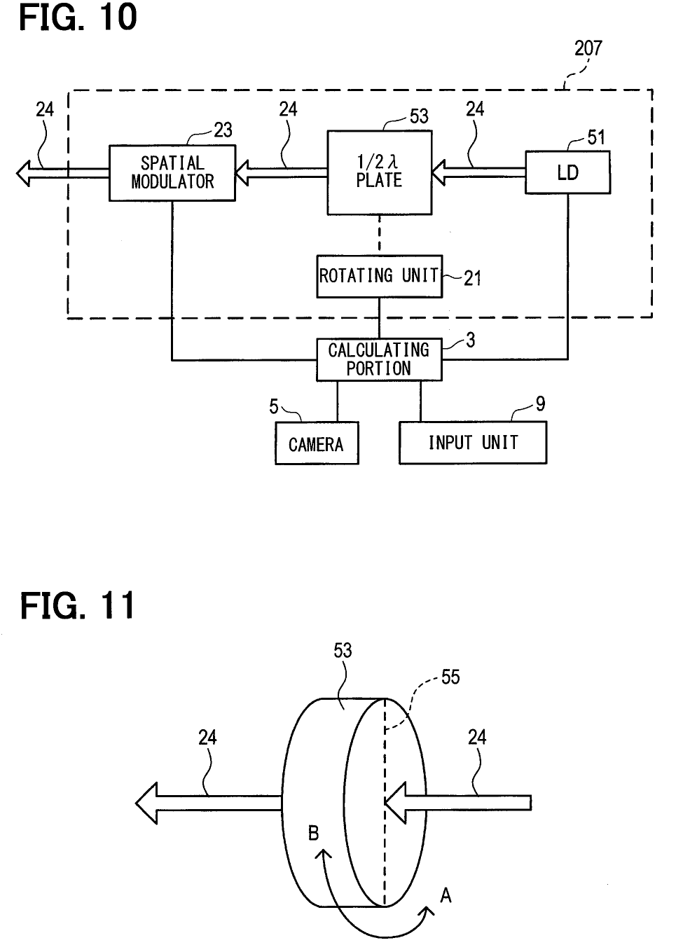

As shown in FIG. 11, the rotating unit 21 rotates the ½λ plate 53 in A direction or B direction to change the angle of the ½λ plate 53. These rotation directions are a direction in which a gradient of an optical axis 55 of the ½λ plate 53 changes with respect to a polarization direction of the light 24 entering the ½λ plate 53.

The P/S ratio of the light 24 passing through the ½λ plate 53 varies depending on the angle of the ½λ plate 53. That is, depending on the angle of the ½λ plate 53, the P/S ratio of the light 24 passing through the ½λ plate 53 is changed to a ratio substantially including only P-polarized light and is changed to a ratio substantially including only S-polarized light.

The rotating unit 21 is controlled by the polarization controlling unit 11 of the calculating portion 3. By controlling the rotating unit 21, the polarization controlling unit 11 can set the P/S ratio of the light 24 passing through the ½λ plate 53 (i.e., the light 24 entering the road surface 27) into the ratio substantially including only P-polarized light and the ratio substantially including only S-polarized light.

2. Effects of Road Surface Displaying Device 1

According to the above described third embodiment, the following effects are achieved in addition to the effects (1A) (1B), (1E) of the previously described first embodiment.

(3A) The road surface displaying device 1 includes the LD 51 as the light source and sets the P/S ratio by using the ½λ plate 53. As such, the P/S ratio is set by simple structures.

(3B) The road surface displaying device 1 sets the P/S ratio by rotating the ½λ plate 53. As such, the P/S ratio is set by simple structures.

### Fourth Embodiment

1. Differences from First Embodiment

Basic structures of the fourth embodiment are similar to the first embodiment. Therefore, descriptions of common structures will be omitted and different structures will be mainly described.

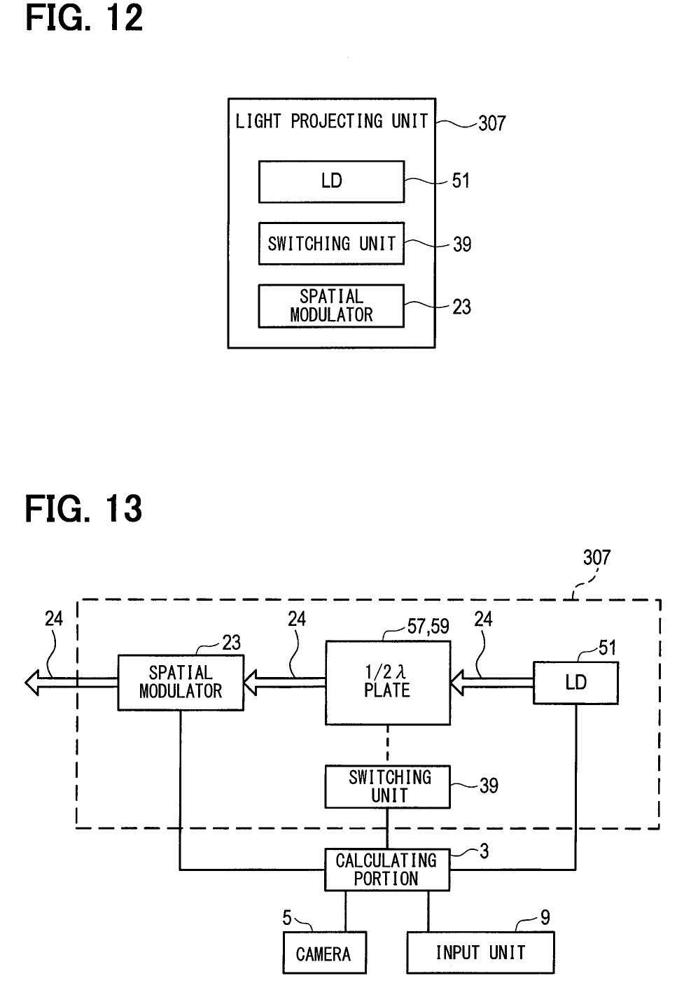

As shown in FIG. 12, the light projecting unit 307 includes the LD 51 as the light source and includes the switching unit 39. As shown in FIG. 13, the light projecting unit 307 includes the ½λ plates 57 and 59. The light 24 emitted by the LD 51 passes through one of the ½λ plates 57 and 59 and is spatially modulated by the spatial modulator 23, and then is projected toward the road surface.

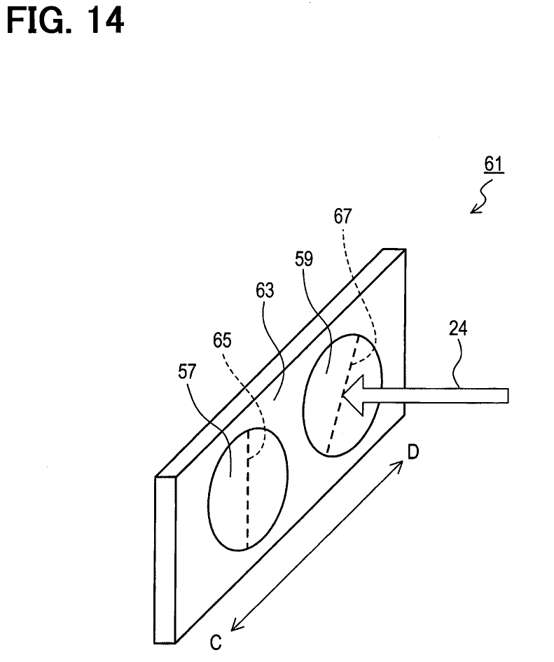

The light projecting unit 307 includes the ½λ plate holder 61 shown in FIG. 14. The ½λ plate holder 61 includes two ½λ plates 57, 59 and a frame 63 holding the ½λ plates 57 and 59. The optical axis 65 of the ½λ plate 57 is shifted from the optical axis 67 of the ½λ plate 59 by 45 degrees. The P/S ratio of the light 24 passing through the ½λ plate 57 is the ratio substantially including only P-polarized light. The P/S ratio of the light 24 passing through the ½λ plate 59 is the ratio substantially including only S-polarized light. The ½λ plates 57 and 59 are one example of a group of the plates whose directions of optical axes are different from each other.

The switching unit 39 slides the ½λ plate holder 61 in C direction or D direction shown in FIG. 14. When the switching unit 39 slides the ½λ plate holder 61 in the C direction, the ½λ plate 59 is located on the optical axis of the light 24 and the ½λ plate 57 is located out of the optical axis of the light 24. In this case, the P/S ratio of the light 24 passing through the ½λ plate 59 is the ratio substantially including only S-polarized light.

On the other hand, when the switching unit 39 slides the ½λ plate holder 61 in the D direction, the ½λ plate 57 is located on the optical axis of the light 24 and the ½λ plate 59 is located out of the optical axis of the light 24. In this case, the P/S ratio of the light 24 passing through the ½λ plate 57 is the ratio substantially including only P-polarized light. That is, the switching unit 39 selects the polarization plate to be located on the optical axis of the light 24 from the ½λ plates 57 and 59.

The switching unit 39 is controlled by the polarization controlling unit 11 of the calculating portion 3. By controlling the switching unit 39 to slide the ½λ plate holder 61 in the C direction or the D direction, the polarization controlling unit 11 can set the P/S ratio of the light 24 entering the road surface 27 into the ratio substantially including only P-polarized light and the ratio substantially including only S-polarized light.

2. Effects of Road Surface Displaying Device 1

According to the above described fourth embodiment, the following effects are achieved in addition to the effects (1A), (1B) and (1E) of the previously described first embodiment.

(4A) The road surface displaying device 1 includes the LD 51 as the light source and sets the P/S ratio by using the ½λ plates 57 and 59. As such, the P/S ratio is set by simple structures.

(4B) The road surface displaying device 1 sets the P/S ratio by selecting the ½λ plate located on the optical axis of the light 24 from the ½λ plates 57 and 59 having the direction of the optical axis different from each other. As such, the P/S ratio is set by simple structures.

### Other Embodiments

Although the embodiments are described hereinabove, the present disclosure is not limited to the above embodiments and may include several modifications.

(1) In the above first to fourth embodiments, the P/S ratio set by the polarization controlling unit 11 may include both of the P-polarized light and the S-polarized light. For example, at the step 4, the P/S ratio may be set to a ratio including 80% of P-polarized light and 20% of S-polarized light, and at the step 8, the P/S ratio may be set to a ratio including 20% of P-polarized light and 80% of S-polarized light.

(2) In the above first to fourth embodiments, the light to be projected on the road surface may be a light that does not express the image such as letters and figures. For example, the light may be a light having uniform illuminance and color regardless of the position.

(3) In the above second embodiment, the polarization plate holder 40 may hold three or more polarization plates. In this case, by sliding the polarization plate holder 40, one polarization plate to be located on the optical axis of the light 24 is selected from a group of three or more polarization plates.

In the above fourth embodiment, the ½λ plate holder 61 may hold three or more ½λ plates. In this case, by sliding the ½λ plate holder 61, one plate located on the optical axis of the light 24 is selected from a group of three or more ½λ plates.

(4) In the above first to fourth embodiments, as the spatial modulator 23, a liquid crystal panel, a galvanoscanner and the like may be employed instead of the DMD.

(5) In the above second embodiment, the switching unit 39 may select one polarization plate to be located on the optical axis of the light 24 by rotating the polarization plate holder 40. In the above fourth embodiment, the switching unit 39 may select one ½λ plate to be located on the optical axis of the light 24 by rotating the ½λ plate holder 61.

(6) In the above first to fourth embodiment, method for setting the first region 29 and the second region 33 may be suitably selected. For example, the method may be employed in which the first region 29 is set as described in the first embodiment and the other region is set as the second region 33. The method may be employed in which the second region 33 is set as described in the first embodiment the other region is set as the first region 29.

(7) In the above first to fourth embodiments, the processing when the negative determination is made at the step 7 may be changed. For example, the display may be performed even when the negative determination is made at the step 7. In this case, the P/S ratio of the light 24 may be suitably set. For example, the P/S ratio may be the ratio substantially including only P-polarized light, the ratio substantially including only S-polarized light, or intermediate ratio thereof.

(8) For example, a function of one of elements of the above embodiments may be dispersed in multiple elements, or functions of multiple elements may be combined in one of the elements. At least a part of the elements of the above embodiments may be replaced by an element having similar function. A part of the elements of the above embodiments may be omitted. At least a part of the elements of the above embodiments may be added to the other embodiments, or at least a part of the elements of the above embodiments may be replaced in the other embodiments.

(9) The present disclosure may be implemented in various ways, other than the above described road surface displaying device, such as a system including the road surface displaying device as an element, a program allowing a computer to function as the calculating portion of the road surface displaying device, a media storing the program, a method for the road surface display and the like.

1. A road surface displaying device comprising:
a light projecting unit that projects light toward a road surface and performs a display by the light on the road surface;
a polarization controlling unit that sets a ratio of P-polarized light and S-polarized light in the light; and
a target position detecting unit that detects a position of a target, wherein
the polarization controlling unit sets the ratio according to the position of the target.

2. (canceled)

3. The road surface displaying device according to claim 1, wherein
the light projecting unit includes a circularly polarized light source as a light source of the light, and
the polarization controlling unit sets the ratio by using a polarization plate located on an optical axis of the light.

4. The road surface displaying device according to claim 3, wherein
the polarization controlling unit sets the ratio by rotating the polarization plate or by selecting the polarization plate from a group of polarization plates whose directions of optical axes are different from each other.

5. The road surface displaying device according to claim 1, wherein
the light projecting unit includes a linearly polarized light source as a light source of the light, and
the polarization controlling unit sets the ratio by using a ½λ plate located on an optical axis of the light.

6. The road surface displaying device according to claim 5, wherein
the polarization controlling unit sets the ratio by rotating the ½λ plate or by selecting the ½λ plate from a group of ½λ plates whose directions of optical axes are different from each other.

7. The road surface displaying device according to claim 1, wherein
the light projecting unit projects the light expressing an image.
